(19) United States
(12) Patent Application Publication
(10) Pub. No.: US 2020/0088252 A1
(43) Pub. Date: Mar. 19, 2020

(54) Transmission Control System, Method, and Apparatus

(71) Applicant: Stanley Wierzbowski, III, Medford, NY (US)

(72) Inventor: Stanley Wierzbowski, III, Medford, NY (US)

(21) Appl. No.: 16/160,644

(22) Filed: Oct. 15, 2018

Related U.S. Application Data
(60) Provisional application No. 62/731,938, filed on Sep. 16, 2018.

(51) Int. Cl. F16D 48/02; F16H 61/02; F16H 61/00

(52) U.S. Cl. CPC F16D 48/0206; F16H 61/0206; F16D 25/14; F16D 2048/0266; F16H 61/0269; F16D 2048/0221; F16H 61/0021

(57) ABSTRACT

An apparatus is disclosed. The apparatus has a first valve assembly that is actuatable between a first position and a second position, a transmission component fluidly connected to the first valve assembly, and a second valve assembly, which is actuatable between a first position and a second position, fluidly connected to the first valve assembly. The first valve assembly is disposed between the second valve assembly and the transmission component. The transmission component is locked when the first valve assembly is in its first position. The transmission component is unlocked when the first valve assembly is in its second position. A pressurized transmission fluid bypasses the second valve assembly when the second valve assembly is in either its first position or its second position.

### FIELD OF THE INVENTION

The present disclosure generally relates to a transmission control system, method, and apparatus. For example, the present disclosure relates to a transmission control system, method, and apparatus for simultaneously locking two separate gears.

### CROSS-REFERENCE TO RELATED APPLICATIONS

This application claims the benefit of the following provisional application which is hereby incorporated by reference in its entirety: 62/731,938 filed Sep. 16, 2018, the entire disclosure of which is incorporated herein by reference.

### BACKGROUND OF INVENTION

In the field of vehicle transmissions, it may be useful to be able to lock two gears or clutches at the same time. For example in vehicles having a torque converter, it may be useful to lock two gears or clutches simultaneously to build up hydraulic pressure before a vehicle is launched. Such a technique, for example, may be used as part of a transbrake for car racing (e.g., in drag racing).

It is common in certain applications of vehicular use, such as drag racing, to modify an existing transmission to optimize a vehicle for use as a race car. Often times, though, conventional transmission configurations and schemes may prevent two gears or clutches from being locked simultaneously. For example, transmissions such as the 6L80/6L90 transmission are configured to prevent two gears or clutches from being locked simultaneously.

Therefore, there is a need in the art for a transmission control system that allows two gears or clutches of at least some conventional transmissions to be simultaneously locked.

The exemplary disclosed system and method of the present disclosure is directed to overcoming one or more of the shortcomings set forth above and/or other deficiencies in existing technology.

### SUMMARY OF THE INVENTION

In one exemplary aspect, the present disclosure is directed to an apparatus. The apparatus includes a first valve assembly that is actuatable between a first position and a second position, a transmission component fluidly connected to the first valve assembly, and a second valve assembly, which is actuatable between a first position and a second position, fluidly connected to the first valve assembly. The first valve assembly is disposed between the second valve assembly and the transmission component. The transmission component is locked when the first valve assembly is in its first position. The transmission component is unlocked when the first valve assembly is in its second position. A pressurized transmission fluid bypasses the second valve assembly when the second valve assembly is in either its first position or its second position.

In another aspect, the present disclosure is directed to a method. The method includes actuating a first transmission control valve assembly between a first position and a second position, the first transmission control valve assembly being disposed upstream from a transmission component, providing a second transmission control valve assembly upstream from the first transmission control valve assembly, pressurizing a transmission fluid at a location that is upstream from the second transmission control valve assembly, and directing a pressurized flow of the transmission fluid to bypass the second transmission control valve assembly. The method also includes continuously applying the pressurized flow to the first transmission control valve assembly, irrespective of an actuating position of the second transmission control valve assembly, allowing the pressurized flow to pass through the first transmission control valve assembly in its first position to lock the transmission component, and blocking the pressurized flow using the first transmission control valve assembly in its second position to unlock the transmission component.

### BRIEF DESCRIPTION OF THE DRAWINGS

FIG. 1 is a perspective view of an exemplary vehicle that may include exemplary embodiments of the present disclosure;

FIG. 2 is a perspective view of an exemplary vehicle that may include exemplary embodiments of the present disclosure;

FIG. 3 is a block diagram illustrating an exemplary transmission system in accordance with at least some exemplary embodiments of the present invention;

FIG. 4 is a schematic illustration of an exemplary transmission system in accordance with at least some exemplary embodiments of the present invention;

FIG. 5 is a schematic illustration of an exemplary transmission system in accordance with at least some exemplary embodiments of the present invention;

FIG. 6 is a schematic illustration of an exemplary transmission system in accordance with at least some exemplary embodiments of the present invention;

FIG. 7 illustrates an exemplary process flow of at least some exemplary embodiments of the present disclosure; and

FIG. 8 illustrates an exemplary process flow of at least some exemplary embodiments of the present disclosure.

### DETAILED SPECIFICATION

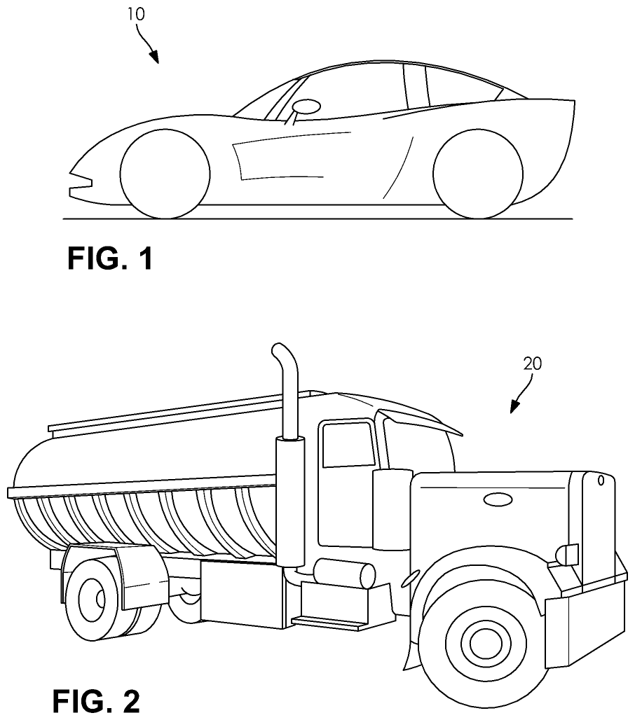

FIGS. 1 and 2 illustrate exemplary vehicles that may include the exemplary disclosed system and apparatus (e.g., a vehicle 10 such as a vehicle designed for high performance racing or a vehicle 20 such as a commercial vehicle, e.g., a truck). Exemplary vehicles that may include the exemplary system and apparatus may be vehicles that include a power source such as an engine, a powertrain, tires, and/or a vehicle operator station. Also for example, any other suitable vehicle or other suitable motorized apparatus may include the exemplary system and apparatus.

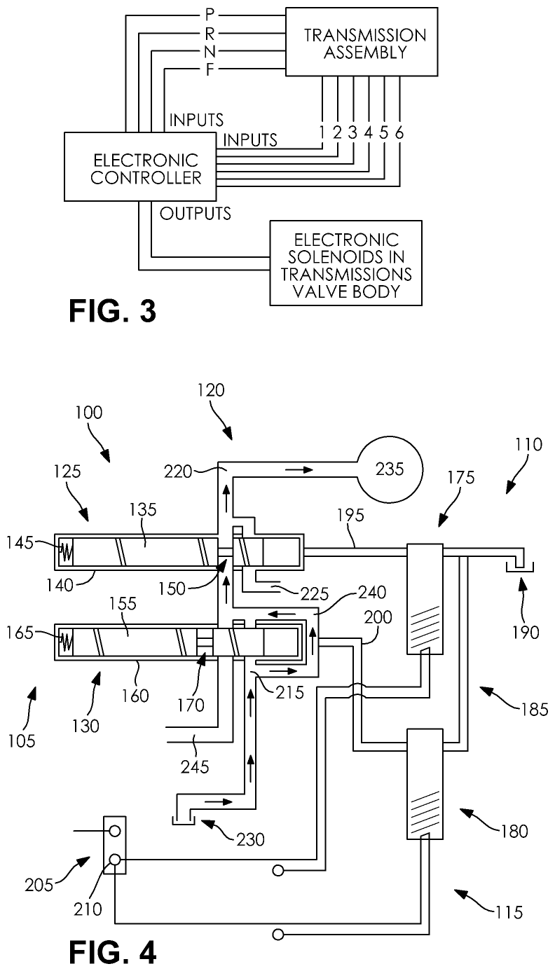

FIG. 3 illustrates an exemplary transmission system, which may be operable for control of a vehicle having an engine and a transmission. The exemplary transmission system may include a plurality of gears or clutches and may have a plurality of gear ratios and may enable the operator of a vehicle to control a gear ratio of the exemplary system. The exemplary transmission system may include an electronic controller, a plurality of gears or clutches, a shifter assembly, a solenoid/servo/actuator activated valve body and one or more wiring harnesses and/or mechanical linkages.

In at least some exemplary embodiments, the electronic controller may include one or more devices configured to allow for the processing of input data and may provide for changes in gear ratios based on a processing of that data. The electronic controller may include a computer readable medium or memory that is configured to store and utilize software-implemented elements for instructing the one or more processing devices to take specific actions related to the switching of gears based on data provided to the electronic controller. In at least some exemplary embodiments, the exemplary electronic controller may include one or more input devices, one or more processing devices, and/or one or more solenoid/servo/actuator driver devices. The electronic controller may for example be electrically connected to a plurality of electronic solenoids that control an operation of transmission valves and other components of an exemplary transmission (e.g., shifter assembly).

In at least some exemplary embodiments, the one or more input devices may include sensors (e.g., a throttle position sensor, an RPM sensor, a ground speed sensor, and/or any other suitable sensor), switches, and/or any other suitable sensor. The one or more processing devices of the exemplary system may include a processing device, a read only memory (ROM), a random access memory (RAM), and/or a storage medium. For example, the processing device may be configured to read input from the one or more input devices and process the input from the input devices in order to select the needed activations and output the needed activations to one or more driver boards.

In at least some exemplary embodiments, the one or more driver boards may activate one or more solenoids, servos, and/or actuators. One or more electrical wiring harnesses may connect electrical components of the system to one another. For example, the exemplary system may include mechanical linkages for connecting mechanical components to each other.

As described further below, the exemplary system may include one or more transmission regulator valves and one or more clutch select valves that actuate to control an operation (e.g., engagement or locking) of one or more respective gears or clutches of an exemplary transmission. The exemplary system may also include one or more solenoids or other suitable devices for selectively controlling an actuation of the exemplary regulator valves and clutch select valves. Control electronics, as further described below, may control an operation of the solenoids or other suitable devices, thereby controlling an operation of the exemplary valves. The engagement or application of one, two, or more clutches or gears of an exemplary transmission may thereby be controlled by the exemplary system (e.g., as described further below).

FIG. 4 illustrates an exemplary system 100 that may be a transmission control system. One or a plurality of systems 100 may be partially or substantially integrated into the exemplary systems of FIGS. 1-3. For example, system 100 may be included at one or more gears or clutches of an exemplary transmission. System 100 may include a flow control system 105, an actuation system 110, a control system 115, and a passage system 120.

As illustrated in FIG. 4, flow control system 105 may include one or more valves and/or any other suitable system for controlling flow of a material through system 100. Flow control system 105 may be any suitable type of flow control system such as, for example, (e.g., a part of) a hydraulic system, pneumatic system, and/or any other suitable type of system. For example, flow control system 105 may include a plurality of valves and/or other suitable devices for controlling a flow of material. Flow control system 105 may for example include a valve assembly or valve 125 and a valve assembly or valve 130.

Valves 125 and 130 may be any suitable type of control valve for controlling a flow of material through system 100. For example, valves 125 and 130 may be any suitable type of two-way valve or other suitable valve. For example, valves 125 and 130 may be piston valves, shuttle valves, butterfly valves, and/or any other suitable type of valve. Valves 125 and 130 may be solenoid-operated, mechanically-actuated, pneumatically-actuated, and/or actuated in any other suitable manner. Valve 125 may be for example a regulator valve (e.g., transmission regulator valve) and valve 130 may be for example a clutch select valve (e.g., a transmission clutch select valve). Valve 130 may be located upstream from valve 125 (e.g., valve 130 may be located closer to a source of pressurized flow of passage system 120 than valve 125).

In at least some exemplary embodiments, valve 125 may include a member 135 (e.g., a piston or other suitable member) that may be movably disposed within a housing 140. Member 135 may be selectively moved between two or more positions within housing 140. An urging member 145 may attach an end portion of member 135 to an end portion of an interior cavity of housing 140. Urging member 145 may be any suitable potential-energy-storing member that may be stretched and unstretched and/or compressed and uncompressed (e.g., urged or biased between a neutral or unbiased state that stores substantially no potential energy and a biased state that stores potential energy). Urging member 145 may be, for example, a spring, an elastic member such as an elastic band, cable, or wire, and/or any suitable member formed from materials having elastic or resilient properties and capable of being stretched and unstretched (e.g., or compressed and uncompressed). For example, urging member 145 may be formed from metallic material, plastic material, composite material, elastomeric material, natural rubber, synthetic rubber, and/or any other suitable material.

A portion of the interior cavity of housing 140 that is distal from urging member 145 may be configured to selectively receive an actuating material via an operation of actuation system 110 as described for example below. Member 135 may be selectively moved within housing 140 based on an operation of urging member 145 and actuation system 110 as described for example below. Member 135 may include an aperture 150 that may selectively allow flow via passage system 120 through valve 125 based on a position of member 135 as described for example below.

In at least some exemplary embodiments, the interior cavity of housing 140 may be selectively supplied with pressurized fluid and drained of pressurized fluid, via an operation of actuation system 110, to cause member 135 to displace within housing 140. A flow rate of fluid or other material into and out of the interior cavity of housing 140 may relate to a velocity of a movement of member 135. An imbalance of force caused by fluid pressure (e.g., a relatively higher fluid pressure on one side of valve 125 based on an operation of actuation system 110) may result in movement of member 135 within housing 140.

Valve 130 may include a member 155, a housing 160, an urging member 165, and an aperture 170 that may be similar to member 135, housing 140, urging member 145, and aperture 150, respectively, of valve 125.

Actuation system 110 may include one or more actuators that may actuate components of flow control system 105. For example, actuation system 110 may include an actuator 175, an actuator 180, and a passage system 185. Actuator 175, actuator 180, and passage system 185 may operate together to actuate valves 125 and 130.

Actuators 175 and 180 may be any suitable actuators for selectively actuating a movement of members 135 and 155 of valves 125 and 130, respectively. Actuators 175 and 180 may be any suitable type of actuators such as, for example, solenoid actuators, mechanical actuators, pneumatic actuators, and/or any other suitable type of actuators. For example, actuators 175 and 180 may include solenoids or any other suitable electromagnetic or electrical actuator that may selectively control a flow of fluid or other material within passage system 185.

Passage system 185 may include a reservoir 190 that may be configured to hold a fluid or other material for example at low pressure. It is also contemplated that reservoir 190 may hold a fluid or other suitable material at high pressure (e.g., greater than an ambient pressure or a relatively greater pressure than other portions of passage system 185). Passage system 185 may selectively draw a fluid such as a hydraulic fluid (e.g., hydraulic oil) from reservoir 190 and return the fluid to reservoir 190. Reservoir 190 may be any suitable container for holding a fluid or other material such as, for example, a fluid tank. Passage system 185 may also include a passage 195 and a passage 200 that may transport a fluid or material to interior cavities of valve 125 and valve 130, respectively. Passage system 185 may also include return passageways and/or other return lines for returning fluid and/or other material to reservoir 190. Passage system 185 may also include one or more pumps or other pressurization sources for pressurizing a flow of fluid or other suitable material within passage system 185. Actuators 175 and 180 may thereby selectively control a flow of fluid via passage system 185 to interior cavities of valves 125 and 130, respectively, to control an actuation of valves 125 and 130.

Control system 115 may include a controller 205 and a plurality of electrical lines that may connect controller 205, actuators 175 and 180, and other components of system 100 (e.g., power source components and transmission components). Controller 205 may be for example an electronic control unit (ECU). For example, controller 205 may include a control 210 such as a button (e.g., a push button), a switch, and/or any other suitable element. Controller 205 may additionally include any suitable operator interface, sensors, and/or any other suitable elements. Controller 205 may be any type of programmable logic controller known in the art for automating machine processes. Controller 205 may include input/output arrangements having electrical lines that allow the controller to be connected to actuators 175 and 180 and any other desired components of system 100. Using controller 205 (e.g., control 210), a user of system 100 such as a driver of a vehicle may control an operation of actuators 175 and 180, thereby controlling valves 125 and 130 to control an operation of system 100.

Passage system 120 may include a plurality of passages that transfer a fluid or other suitable material through system 100. For example, passage system 120 may transport transmission fluid through system 100 to control a transmission of a vehicle or other machine as described for example herein. Passage system 120 may include a plurality of passages 215, 220, and 225, and a reservoir 230 that may be similar to reservoir 190. Passage system 120 may selectively draw a fluid such as a transmission fluid from reservoir 230 and transport the fluid via passages 215 and 220 to a transmission component 235 such as a gear or clutch. Passage 215 may include a passage portion 240 that may bypass valve 130. For example, irrespective of a position of valve 130, passage system 120 may transfer pressurized fluid around (e.g., bypassing) valve 130 to maintain pressure (e.g., substantially constant pressure) on valve 125. Also for example in the case of a modified system (e.g., a system in which an exemplary system is modified to include a passage portion 240), passage portion 240 may bypass valve 130 so that passage 225 may serve as a return line instead of a passage 245. Passage 220 may connect passage portion 240 to transmission component 235, and may transfer fluid or other suitable material to transmission component 235 based on a position of valve 125 as described for example below. Passage 225 may be a return line that returns fluid and/or other material to reservoir 230 and/or other reservoirs of passage system 120 based on a position of valve 125 as described for example below. Passage system 120 may also include one or more pumps or other pressurization sources for pressurizing a flow of fluid or other material within passage system 120. Fluid and/or other material may flow through passage system 120 based on a position of valve 125 as described for example below.

Components of flow control system 105, actuation system 110, control system 115, and/or passage system 120 may be formed from any suitable material for transporting and/or controlling a transfer of fluid and/or other suitable material through system 100. For example, flow control system 105, actuation system 110, control system 115, and/or passage system 120 may be formed from any suitable structural material such as metal, metal alloy, plastic, plastic composite, elastomeric, ceramic, and/or any other suitable materials for transferring and/or controlling a transfer of fluid and/or other suitable materials.

In at least some exemplary embodiments, the exemplary disclosed apparatus may include a first valve assembly (e.g., valve 125) that is actuatable between a first position and a second position, a transmission component (e.g., transmission component 235) fluidly connected to the first valve assembly, and a second valve assembly (e.g., valve 130), which is actuatable between a first position and a second position, fluidly connected to the first valve assembly. The first valve assembly may be disposed between the second valve assembly and the transmission component. The transmission component may be locked when the first valve assembly is in its first position. The transmission component may be unlocked when the first valve assembly is in its second position. A pressurized transmission fluid may bypass the second valve assembly when the second valve assembly is in either its first position or its second position. The pressurized transmission fluid may apply pressure to the first valve assembly irrespective of whether the second valve assembly is in its first position or its second position. The first valve assembly may be a transmission regulator valve assembly. The second valve assembly may be a transmission clutch select valve assembly. The transmission component may be a gear or a clutch of a transmission. The transmission component may be one of a plurality of transmission components of the transmission that are locked when the first valve assembly is in the first position. The transmission may be selected from the group consisting of a 6L80 transmission and a 6L90 transmission. The transmission may be a drag racing car transmission. The exemplary disclosed apparatus may further include a first actuator (e.g., actuator 175) configured to actuate the first valve assembly and a second actuator (e.g., actuator 180) configured to actuate the second valve assembly. The exemplary disclosed apparatus may also include a controller (e.g., controller 205) that is electrically connected to the first actuator and the second actuator. The controller may include a push button, the first valve assembly moving to its first position when the push button is pushed and the first valve assembly moving to its second position when the push button is released. The exemplary disclosed apparatus may be a transmission control system of a vehicle, and the vehicle may build up hydraulic pressure when the first valve assembly is in its first position.

In at least some exemplary embodiments, the exemplary disclosed system may be a vehicle transbrake system including a transmission regulator valve assembly (e.g., valve 125) that is actuatable between a first position and a second position, a vehicle transmission gear (e.g., transmission component 235) fluidly connected to the transmission regulator valve assembly, and a transmission clutch select valve assembly (e.g., valve 130), which is actuatable between a first position and a second position, fluidly connected to the transmission regulator valve assembly. The transmission regulator valve assembly may be disposed between the transmission clutch select valve assembly and the vehicle transmission gear. The vehicle transmission gear may be locked when the transmission regulator valve assembly is in its first position. The vehicle transmission gear may be unlocked when the transmission regulator valve assembly is in its second position. A pressurized transmission fluid may bypass the transmission clutch select valve assembly when the transmission clutch select valve assembly is in either its first position or its second position. The exemplary disclosed system may further include a first solenoid (e.g., actuator 175) configured to actuate the transmission regulator valve assembly and a second solenoid (e.g., actuator 180) configured to actuate the transmission clutch select valve assembly. The exemplary disclosed system may also include a second vehicle transmission gear, the vehicle transmission gear being a first vehicle transmission gear, wherein the first and second vehicle transmission gears may be locked when the transmission regulator valve assembly is in its first position. The first vehicle transmission gear may be unlocked and the second vehicle transmission gear may be locked when the transmission regulator valve assembly is in its second position.

The exemplary disclosed system, method, and apparatus may be used in any application involving simultaneously locking two gears or clutches of a transmission. For example, the exemplary disclosed system, method, and apparatus may be used as part of a transbrake of a vehicle used for car racing such as drag racing. Also for example, the exemplary disclosed system, method, and apparatus may be used in any application involving building up hydraulic pressure in a vehicle prior to operation. The exemplary disclosed system, method, and apparatus may be used in any suitable vehicle having a transmission and torque converter in which building up hydraulic pressure may be a part of a desired operation. The exemplary disclosed system, method, and apparatus may be used in any suitable vehicle or mechanical system such as, for example, vehicles such as cars and trucks, military and emergency vehicles involving operations that build up hydraulic pressure before a launch or other suitable action, and/or any other suitable vehicle or machine.

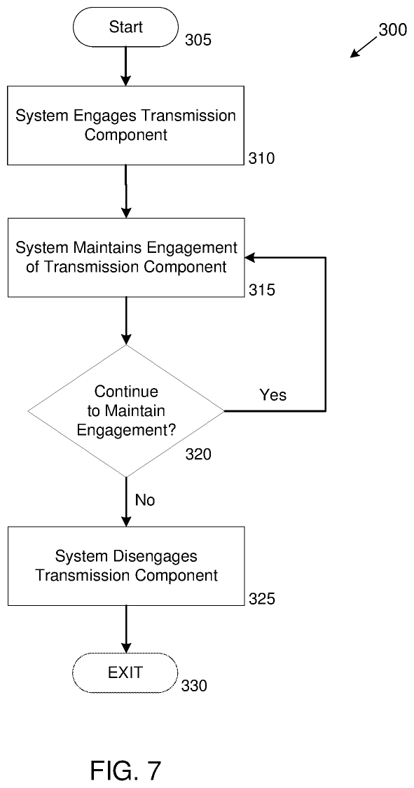

An exemplary operation of the exemplary disclosed system, method, and apparatus will now be described. For example, FIG. 7 illustrates an exemplary process 300 for an operation of exemplary system 100. Process 300 starts at step 305.

At step 310, the exemplary system and apparatus may operate to engage an exemplary component such as transmission component 235 of system 100. For example as illustrated in FIG. 4, a user may use controller 205 to activate system 100. For example, a user may use control 210 to input a command to system 100 to engage exemplary transmission component 235. In at least some exemplary embodiments, control 210 may be a button such as a push button that a user may press to engage transmission component 235. System 100 may also automatically issue a command to engage exemplary transmission component 235 based on for example an algorithm and/or other predetermined criteria (e.g., based on a predetermined time, time interval, or other suitable conditions).

At step 310, controller 205 may control actuator 175 to move valve 125 to the position illustrated in FIG. 4 based on the exemplary command described above. Actuator 175 may operate to transfer fluid or other suitable material (e.g., hydraulic fluid) from reservoir 190 to the interior cavity of housing 140 of valve 125. Member 135 may be urged based on the pressure increase of fluid transferred to valve 125 based on an operation of actuator 175. Member 135 may move, thereby compressing urging member 145. Aperture 150 may thereby be moved to a position that is substantially aligned with passage 220, thereby allowing a flow of fluid of passage system 120 (e.g., transmission fluid) through valve 125.

Similar to an operation of actuator 175, actuator 180 may operate to transfer fluid or other material to move member 155 of valve 130 to a desired position as illustrated in FIG. 4. For example, valve 130 may substantially block a flow of fluid or other material through valve 130 (e.g., aperture 170 may be located in a position that may not be aligned with passage 245) as a flow of fluid flows through passage portion 240. In at least some exemplary embodiments, valve 130 may be moved based on an operation of actuator 180 and commands from controller 205 to correspond to an overall computer-driven operation of system 100 (e.g., to operate consistently with other control systems for example of vehicles 10 or 20). In at least some exemplary embodiments, irrespective of a position of member 155 of valve 130, fluid or other material of passage system 120 may flow around (e.g., bypass) valve 130 as illustrated in FIG. 4. For example, fluid or other material may bypass valve 130 via passage portion 240. Accordingly as illustrated in FIG. 4, fluid or other material (e.g., transmission fluid) may be drawn from reservoir 230, flow through passage 215 (e.g., including flowing through passage portion 240 around valve 130), to passage 220 (e.g., through valve 125 via aperture 150), and to transmission component 235. The fluid or other material (e.g., transmission fluid) may thereby actuate transmission component 235. For example when in the configuration illustrated in FIG. 4, transmission component 235 may be a gear or clutch of a transmission that may be engaged to be locked. In conjunction with an overall operation of a vehicle or machine as described for example herein, one or more systems 100 may lock multiple gears or clutches simultaneously on a transmission.

At step 315, system 100 may maintain an engagement of transmission component 235 as illustrated in FIG. 4. In at least some exemplary embodiments, a user may keep control 210 that may be a button pushed in. Using control 210, a user may maintain an engagement of transmission component 235 for as long as desired. In at least some exemplary embodiments when system 100 is used as part of a transbrake of a vehicle having a torque converter, one or more systems 100 may hold a vehicle stationary while building up hydraulic pressure. For example when system 100 is maintained at step 315, a user who may be a vehicle driver may increase a vehicle throttle to any desired amount without moving the vehicle. In at least some exemplary embodiments when system 100 is used as part of a transbrake for a drag racing car, the user may maintain system 100 at step 315 just prior to the start of a race in order to build up desired hydraulic pressure. For example, the user may apply throttle to provide a drag racing car with a desired amount of torque reserve (e.g., 300 ft-lbs or more, between about 1500 ft-lbs and about 3700 ft-lbs, or any other desired amount) just prior to a start of a race.

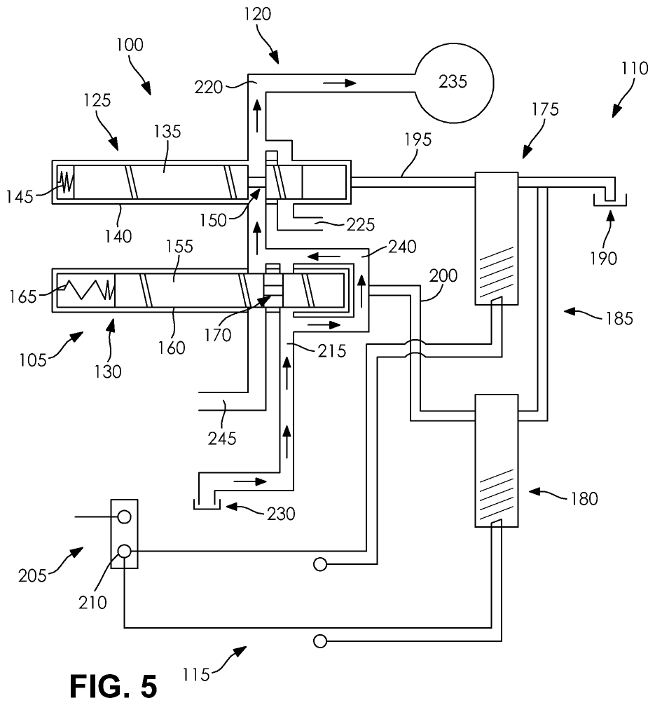

FIG. 5 illustrates an additional exemplary embodiment for maintaining system 100 in a desired configuration at steps 310 and 315. For example, FIG. 5 illustrates an alternate position and/or configuration of member 155 of valve 130. For example as illustrated in FIG. 5, valve 130 may also substantially block a flow of fluid or other material through valve 130 (e.g., aperture 170 may be located in a position that may not be aligned with passage 245). Also, fluid or other material of passage system 120 may flow around (e.g., bypass) valve 130. FIGS. 4 and 5 thereby illustrate alternative configurations for maintaining pressure (e.g., substantially constant pressure) on valve 125 irrespective of a position of valve 130.

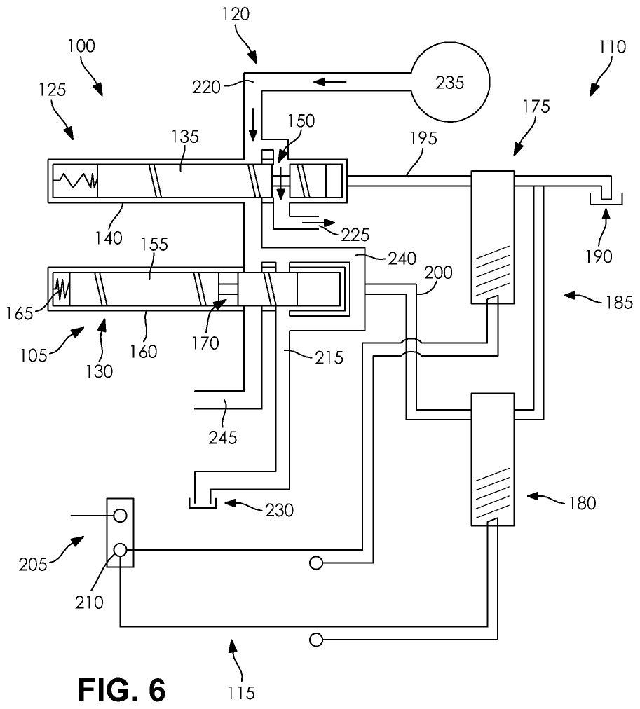

At step 320, a user determines whether or not to maintain system 100 at step 315 as illustrated in FIG. 4 (e.g., or at FIG. 5). In at least some exemplary embodiments, the user may maintain system 100 at the configuration of step 315 based on continuing to push or hold down control 210 that may be a button. At any desired time, the user may command system 100 to disengage and change from the configuration of FIG. 4 (e.g., or FIG. 5) to FIG. 6. In at least some exemplary embodiments, the user may release control 210 (e.g., release control 210 that may be a push button) and system 100 may proceed to step 325 as illustrated in FIG. 6. Also for example, system 100 may automatically change from the configuration of step 315 (e.g., FIG. 4 or 5) to the configuration of step 325 (e.g., FIG. 6) based on predetermined criteria, algorithms, and/or any other suitable criteria.

At step 325, based on exemplary commands and/or input described above, system 100 may operate to change a flow of fluid or other material (e.g., transmission fluid) through system 100. Controller 205 may control actuator 175 to move valve 125 to the position illustrated in FIG. 6 based on the exemplary command described above. Actuator 175 may operate to transfer fluid or other suitable material (e.g., hydraulic fluid) from the interior cavity of housing 140 of valve 125 to reservoir 190. Fluid may thereby be removed from housing 140, thereby reducing a pressure acting from the fluid on member 135. Based on the pressure (e.g., force) being reduced (e.g., based on an operation of actuator 175) to be less than an urging force of urging member 145, urging member 145 may release potential energy (e.g., expand) and thereby move member 135. Aperture 150 may thereby be moved to a position that is substantially aligned with passage 225, thereby allowing a flow of fluid of passage system 120 (e.g., transmission fluid) into passage 225 that may be a return line to reservoir 230. Fluid or other material of passage system 120 (e.g., transmission fluid) may thereby be removed from transmission component 235. Member 135 may also substantially block flow of fluid or other material through passage 215 including passage portion 240. Accordingly for example, substantially no fluid or other material may flow between valve 125 and valve 130. Valve 130 may remain for example be in a position corresponding to FIG. 4 (e.g., or FIG. 5).

When in the configuration illustrated in FIG. 6, transmission component 235 may be a gear or clutch of a transmission that may be disengaged and unlocked. In at least some exemplary embodiments in which system 100 may be part of a transbrake of a vehicle having a torque converter, the unlocking of transmission component 235 that may be a gear or clutch results in the launch of the vehicle. For example during step 325, hydraulic pressure may build up just prior to a start of a race (e.g., a user may have applied throttle to maintain a drag racing car at a desired amount of torque reserve). By disengaging transmission component 325 that may be a gear or clutch to be unlocked, the vehicle launches. In at least some exemplary embodiments, step 325 may occur at the instant a race such as a drag race starts. Also for example, step 325 may occur at a desired time of a launch of a vehicle or machine during any suitable application (e.g., involving building up hydraulic pressure and/or torque reserve). Process 300 may end at step 330.

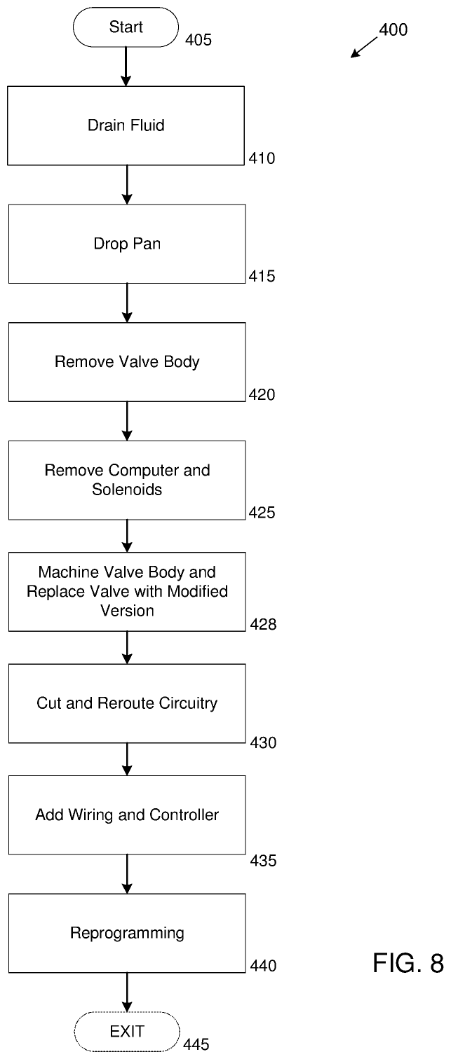

An additional exemplary operation of the exemplary disclosed system, method, and apparatus will now be described. For example, FIG. 8 illustrates an exemplary process 400 for modifying a system to include exemplary system 100. In at least some exemplary embodiments, exemplary process 400 provides an effective technique for modifying the hydraulics system, electronics system, and/or computer system of a transmission system to add or include system 100 (e.g., to allow for a transbrake to be included in a vehicle). In at least some exemplary embodiments, process 400 may be used as part of a procedure for installing a transbrake on a 6L80/6L90 transmission. In at least some exemplary embodiments, after process 400 is performed, any additional suitable components may be added to the transmission to be modified to allow for simultaneously locking multiple opposing gears or clutches. Process 400 starts at step 405.

At step 410, fluid may be drained from a transmission system to be modified. At step 415, a vehicle pan may be removed (e.g., dropped). At step 420, a valve body of the transmission system to be modified may be removed. At step 425, a computer (e.g., with integrated solenoids) may be removed from a side portion of the valve body of the transmission system. At step 428, the valve body may be machined and the valve member (e.g., member 155) may be replaced with a modified valve member.

At step 430, circuitry of the transmission system to be modified may be cut and rerouted. At step 435, a portion of the circuitry may be disposed through the transmission case (e.g., run through the transmission case pass-through plug) so that wiring may be added (externally added from the transmission) to connect to controller 205 (e.g., control 210) that may be added. For example, controller 205 may be disposed within easy reach of a driver. At step 440, the computer system (e.g., computer system with integrated solenoids removed in step 425) of the transmission system to be modified may be reprogrammed to prevent that computer system from going into a failsafe or other undesired mode due to the additional electronics of system 100 being recognized (e.g., controller 205) by one or more vehicle systems. Process 400 may end at step 445.

The exemplary disclosed method may include actuating a first transmission control valve assembly (e.g., valve 125) between a first position and a second position, the first transmission control valve assembly being disposed upstream from a transmission component (e.g., transmission component 235), providing a second transmission control valve assembly (e.g., valve 130) upstream from the first transmission control valve assembly, pressurizing a transmission fluid at a location that is upstream from the second transmission control valve assembly, and directing a pressurized flow of the transmission fluid to bypass the second transmission control valve assembly. The exemplary disclosed method may also include continuously applying the pressurized flow to the first transmission control valve assembly, irrespective of an actuating position of the second transmission control valve assembly, allowing the pressurized flow to pass through the first transmission control valve assembly in its first position to lock the transmission component, and blocking the pressurized flow using the first transmission control valve assembly in its second position to unlock the transmission component. The exemplary disclosed method may further include locking a second transmission component of a vehicle transmission when the transmission component, which may be a first transmission component of the vehicle transmission, is locked when the pressurized flow is passing through the first transmission control valve. Locking the first and second transmission components may form a transbrake of the vehicle transmission that is a drag racing car transmission. The exemplary disclosed method may further include actuating the first transmission control valve assembly from its first position to its second position at the start of a car race when the transmission component is a clutch of a drag racing car.

The exemplary disclosed system, method, and apparatus may provide an effective technique for locking two or more gears or clutches simultaneously. The exemplary disclosed system, method, and apparatus may provide an efficient method for modifying a transmission to allow for simultaneous locking of two or more clutches or gears. For example, the exemplary system and method may provide a technique for installing a transbrake on a vehicle used for racing such as drag racing. Also for example, the exemplary system and method may allow for hydraulic pressure to be built up in any desired vehicle or machine prior to a desired activity such as launch of a vehicle.

Exemplary embodiments of the present invention have been described, however, it is not intended to limit the spirit and scope of the invention. It will be understood that various changes in the details, arrangements, and configuration of the parts which have been described and illustrated above in order to explain the nature of the present invention may be made by those skilled in the art within the principle and scope of the present invention as expressed in the appended claims.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (e.g., computing device) can receive such a computer program and, by processing the computational instructions thereof, produce a further technical effect.

A programmable apparatus includes one or more processing means, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular vehicle, computer, or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

What is claimed is:

1. An apparatus, comprising:
a first valve assembly that is actuatable between a first position and a second position;
a transmission component fluidly connected to the first valve assembly; and
a second valve assembly, which is actuatable between a first position and a second position, fluidly connected to the first valve assembly;
wherein the first valve assembly is disposed between the second valve assembly and the transmission component;
wherein the transmission component is locked when the first valve assembly is in its first position;
wherein the transmission component is unlocked when the first valve assembly is in its second position; and
wherein a pressurized transmission fluid bypasses the second valve assembly when the second valve assembly is in either its first position or its second position.

2. The apparatus of claim 1, wherein the pressurized transmission fluid applies pressure to the first valve assembly irrespective of whether the second valve assembly is in its first position or its second position.

3. The apparatus of claim 1, wherein the first valve assembly is a transmission regulator valve assembly.

4. The apparatus of claim 1, wherein the second valve assembly is a transmission clutch select valve assembly.

5. The apparatus of claim 1, wherein the transmission component is a gear or a clutch of a transmission.

6. The apparatus of claim 5, wherein the transmission component is one of a plurality of transmission components of the transmission that are locked when the first valve assembly is in the first position.

7. The apparatus of claim 5, wherein the transmission is selected from the group consisting of a 6L80 transmission and a 6L90 transmission.

8. The apparatus of claim 5, wherein the transmission is a drag racing car transmission.

9. The apparatus of claim 1, further comprising a first actuator configured to actuate the first valve assembly and a second actuator configured to actuate the second valve assembly.

10. The apparatus of claim 9, further comprising a controller that is electrically connected to the first actuator and the second actuator.

11. The apparatus of claim 10, wherein the controller includes a push button, the first valve assembly moving to its first position when the push button is pushed and the first valve assembly moving to its second position when the push button is released.

12. The apparatus of claim 1, wherein the apparatus is a transmission control system of a vehicle, and the vehicle builds up hydraulic pressure when the first valve assembly is in its first position.

13. A method, comprising:
actuating a first transmission control valve assembly between a first position and a second position, the first transmission control valve assembly being disposed upstream from a transmission component;
providing a second transmission control valve assembly upstream from the first transmission control valve assembly;
pressurizing a transmission fluid at a location that is upstream from the second transmission control valve assembly;
directing a pressurized flow of the transmission fluid to bypass the second transmission control valve assembly;
continuously applying the pressurized flow to the first transmission control valve assembly, irrespective of an actuating position of the second transmission control valve assembly;
allowing the pressurized flow to pass through the first transmission control valve assembly in its first position to lock the transmission component; and
blocking the pressurized flow using the first transmission control valve assembly in its second position to unlock the transmission component.

14. The method of claim 13, further comprising locking a second transmission component of a vehicle transmission when the transmission component, which is a first transmission component of the vehicle transmission, is locked when the pressurized flow is passing through the first transmission control valve.

15. The method of claim 14, wherein locking the first and second transmission components forms a transbrake of the vehicle transmission that is a drag racing car transmission.

16. The method of claim 13, further comprising actuating the first transmission control valve assembly from its first position to its second position at the start of a car race when the transmission component is a clutch of a drag racing car.

17. A vehicle transbrake system, comprising:
a transmission regulator valve assembly that is actuatable between a first position and a second position;
a vehicle transmission gear fluidly connected to the transmission regulator valve assembly; and
a transmission clutch select valve assembly, which is actuatable between a first position and a second position, fluidly connected to the transmission regulator valve assembly;
wherein the transmission regulator valve assembly is disposed between the transmission clutch select valve assembly and the vehicle transmission gear;
wherein the vehicle transmission gear is locked when the transmission regulator valve assembly is in its first position;
wherein the vehicle transmission gear is unlocked when the transmission regulator valve assembly is in its second position; and
wherein a pressurized transmission fluid bypasses the transmission clutch select valve assembly when the transmission clutch select valve assembly is in either its first position or its second position.

18. The vehicle transbrake system of claim 17, further comprising a first solenoid configured to actuate the transmission regulator valve assembly and a second solenoid configured to actuate the transmission clutch select valve assembly.

19. The vehicle transbrake system of claim 17, further comprising a second vehicle transmission gear, the vehicle transmission gear being a first vehicle transmission gear, wherein the first and second vehicle transmission gears are locked when the transmission regulator valve assembly is in its first position.

20. The vehicle transbrake system of claim 19, wherein the first vehicle transmission gear is unlocked and the second vehicle transmission gear is locked when the transmission regulator valve assembly is in its second position.
